(19) United States
(12) Patent Application Publication
(10) Pub. No.: US 2018/0245838 A1
(43) Pub. Date: Aug. 30, 2018

(54) Refrigerated cabinet

(71) Applicant: PAN-DUR HOLDING GMBH & CO. KG, RAVENSTEIN (DE)

(72) Inventor: ALBERT WEISS, RAVENSTEIN (DE)

(21) Appl. No.: 15/901,026

(22) Filed: Feb. 21, 2018

(30) Foreign Application Priority Data
Feb. 23, 2017 (DE) 10 2017 103 751.9

(51) Int. Cl. F25D 23/02; E05F 15/70

(52) U.S. Cl. CPC F25D 23/028; E05F 15/70; E05Y 2900/31; E05Y 2201/652; E05Y 2201/71; E05Y 2201/628

(57) ABSTRACT

A self-adjusting door bearing for a door of a refrigerated cabinet includes two longitudinally opposite ends. On one of the opposite ends is a door bearing member for fixing the door bearing on the door of the refrigerated cabinet. On the other one of the opposite sides is a cabinet bearing element for fixing the door bearing on a cabinet head of the refrigerated cabinet. The cabinet bearing element is configured so as to be movable in the longitudinal direction of the door bearing relative to the door bearing member and pivotable relative to the door bearing member.

### FIELD OF THE INVENTION

The present invention relates to refrigerated cabinets and individual characteristics of them, and particularly the bearings by which the doors are carried by the cabinet.

It must also be noted that the individual aspects can also be realized in product display cabinets that do not serve the purpose of the cooling of products, such as food. Thus, the individual characteristics can also be realized in product display cabinets that do not serve as refrigerated cabinets.

### BACKGROUND

Generally, refrigerated cabinets are known in the state of the art that feature doors pivotable around vertical pivot axes, whereas the doors are preferably designed to be transparent and comprise one or more interconnected transparent glass panes.

Such doors have a lower and an upper pivot bearing, or are in in contact with such bearings. While the lower door bearings are usually fixed in place (for example, on a frame of the refrigerated cabinet, to which other elements thereof are directly or indirectly fixed), the upper door bearings are mounted on or in a so-called “cabinet head” or in each case extend in a swivel or pivot bearing that is arranged on the cabinet head.

Preferably, the cabinet head is supported downwards solely by means of a rear wall and/or the two outer side walls of the refrigerated cabinet, which are arranged on the left and right of multiple doors placed next to each other. Between the doors, it is preferable that there are no vertically extending supports or struts, as they would affect the view into the interior product space.

Based on such mounting of the cabinet head, it cannot be ruled out that it will bend downwards in the course of time in the area between the side walls of the refrigerated cabinet. If the upper door bearings were then immovably fixed in the axial direction of the pivot axis of the respective door, given the specified bending, the tilting or blocking of the corresponding upper door bearing would arise after a certain period of time.

### OBJECTS AND SUMMARY OF INVENTION

As such, in accordance with a first aspect of the invention, it is advantageous if the upper door bearings result in a floating mounting of the respective doors. In the following, an advantageous embodiment of a corresponding upper door bearing is described, whereas one corresponding door bearing may be used with multiple, preferably all, doors of the refrigerated cabinet.

It must also be noted that, in addition to a door or a refrigerated cabinet, as the case may be, with one or more corresponding upper door bearings, the subject matter of the invention includes the upper door bearing as such.

Finally, the door bearing in accordance with the invention can be used not only in swivel or pivot doors, which can be swiveled or pivoted around a vertical axis of rotation or pivot axis between an open position and a closed position. Rather, the door bearing can also be used as a bearing for sliding doors, preferably of refrigerated cabinets. Moreover, the door in accordance with the invention comprises only, for example, a swivel door. Likewise, the door may be designed as a sliding door.

Preferably, the upper door bearing comprises a bearing section on the door side (which may be formed in one or more parts) for fixing the door bearing to the door. The bearing section on the door side, for example, may feature a connecting section in the form of at least one bulge or indentation and/or a thread, through which it is connected or connectable in a force-fitting and/or positive-locking manner, and in particular in a torque-proof manner with respect to the door, to a linking area of the door.

The linking area of the door may be, for example, an insert that is at least partially fixed between two glass panes of the door, an extension that at least partially encompasses one or more glass panes of the door or a surface section of the door or one or more glass panes of the door, as the case may be. For example, the connecting section may be glued into a corresponding insert.

Furthermore, the upper door bearing comprises a bearing section on the cabinet head side (which may be formed in one or more parts) for the direct or indirect fixing of the door bearing relative to the cabinet head. The bearing section on the cabinet head side may feature, for example, a connecting section in the form of at least one bulge or indentation and/or a thread, through which it is connected in a force-fitting and/or positive-locking manner to a linking area of the cabinet head.

For example, the bearing section on the cabinet head side may be mounted in a ball bearing or roller bearing, which in turn is fixed directly or indirectly to the cabinet head. Preferably, the bearing section on the cabinet head side is mounted relative to the cabinet head in a manner that is rotatable but immovable in a vertical direction.

Preferably, the bearing section on the cabinet head side is in contact, in particular by means of a swivel bearing, to a gear wheel or a pulley, whereas the pulley in turn is connected, by means of at least one belt and/or the pulley or the gear wheel, to at least one (additional) gear wheel or directly to a drive.

Preferably, the bearing sections on the cabinet head side of two adjacent doors are in operative connection with a common drive.

It is advantageous if the bearing section on the cabinet head side and the bearing section on the door side are preferably exclusively in contact with each other in a positive-locking manner, and form the upper door bearing.

Preferably, the bearing section on the cabinet head side and the bearing section on the door side can be separated from each other without tools and without releasing positive-locking connections, if the upper door bearing or the door with a corresponding door bearing, as the case may be, are not installed in a refrigerated cabinet.

The positive-locking connection is formed in such a manner that, with a door installed in a refrigerated cabinet, the bearing section on the cabinet head side is movable relative to the bearing section on the door side, among other things, in a direction that is co-linear or parallel to the pivot axis of the door.

Furthermore, the connection between the two bearing sections is to be formed in such a manner that the bearing section on the cabinet head side can be tilted in the installed state. Preferably, a tilting from a starting position, that both bearing sections show when the cabinet head is not bent, is possible horizontally in all directions.

The possible tilt angle, beginning from a starting position in which the longitudinal axes of both bearing sections run co-linear relative to each other, features an amount that is between 1° and 20°, whereas the tilt angle is related to the common longitudinal axis of the upper door bearing.

For this purpose, the bearing section on the door side (or the bearing section on the cabinet head side) preferably features one or more recesses or gaps into which one or more bulges of the bearing section on the cabinet head side (or in the alternative case: the bearing section on the door side) engage.

Preferably, the bearing section on the door side (alternatively, the bearing section on the cabinet head side) has an upwardly (or downwardly) open cavity, into which an extension of the section on the cabinet head side (alternatively, the bearing section on the door side) engages. The dimensions of the cavity or the extension, as the case may be, are dimensioned in such a manner that there is a backlash between the cavity and the extension, such that the extension in the cavity can be moved in the vertical direction or in the longitudinal direction of the upper door bearing (if the cabinet head bends).

Similarly, the dimensions are to be such that the extension (with the specified bending of the cabinet head) can be tilted within the cavity.

Preferably, the specified cavity is formed by the fact that the bearing section featuring the cavity is formed as a sleeve, which is open at least in the direction of the bearing section featuring the extension.

The extension preferably comprises a ball-shaped end section, which is placed in the cavity.

Further, the end section preferably has at least one bulge projecting to the side, for example in the form of a bolt projecting away from the side of the end section, which engages in a recess or a section of the wall bounding the cavity.

Due to the interaction of the bulge and the at least partially surrounding recess or the section at least partially surrounding the bulge, as the case may be, the two bearing sections are in contact with each other in a positive-locking manner, in such a manner that the rotation of the bearing section on the cabinet head side around a vertical axis of rotation (which runs co-linear to the longitudinal axis of the upper door bearing) brings about a rotation of the bearing section on the door side around a vertical axis of rotation.

If the bearing section on the cabinet head side is rotated around the specified axis of rotation with the assistance of a drive, the bearing section on the door side also rotates and finally causes the opening or closing of the door.

An additional aspect relates to the drive of doors of a refrigerated cabinet, whereas the door comprises an upper bearing section according to previous or subsequent description. Preferably, the refrigerated cabinet has a multiple number of correspondingly formed doors.

Furthermore, a refrigerated cabinet with multiple doors is described, each of which can be pivoted with the assistance of a drive and around a pivot axis between an open position and a closed position, whereas each door is in operative connection with the drive allocated to it by means of a coupling, whereas the coupling can be transferred from a transmission position into a release position, and vice versa, whereas in the transmission position, a force generated by the drive is transmitted to the door, and whereas the transmission of force from the drive to the door is interrupted in the release position. Furthermore, it is provided that the coupling is formed to assume its release position if a force exerted manually on the door reaches a defined amount, and whereas the coupling is once again transferred to its transmission position after the elimination of the force manually exerted on the door.

Preferably, the drive is connected to one or more (preferably two) doors by means of a drive mechanism. The connection between the door and the drive preferably comprises at least two pulleys, which are connected by means of a belt. While the first pulley may be directly or indirectly connected to an upper bearing section, the second pulley may be in operative connection with a gear wheel or an additional pulley, which in turn is connected to the drive in terms of drive technology.

In particular, each of the upper door bearings of each of the two adjacent doors is to be connected in a torque-proof manner to a pulley, whereas each pulley is connected to a belt with a gear unit connected to a drive, which gear unit in turn comprises at least two gear wheels. In this case, one gear wheel is in contact with each pulley, which in turn is connected by means of a belt to the pulley, which is in contact with an upper door bearing of a door.

Preferably, the drive mechanism comprises one coupling per door. In the normal case, the coupling features a force transmission position, in which it passes on a force (preferably a torque) transmitted to it by the drive to at least one bearing section on the cabinet head side.

Preferably, the coupling is arranged between each pulley and gear wheel of the drive mechanism, whereas the pulley and the gear wheel can be mounted in a torque-proof manner around a common axis of rotation.

If a defined force is exerted on the corresponding door (for example, because the door is manually opened against the closing force of the drive or is closed against the force of the drive, that keeps the door open), the coupling assumes a release position, in which the forwarding of the force from the drive to the corresponding door or in the reverse direction, as the case may be, is interrupted. Thereby, damage to the door or the drive is avoided. The door is freely movable relative to the drive.

The coupling may comprise two coupling elements, which are pressed against each other with the assistance of at least one loading element (for example, a spring). At least one force transmission element (for example, a rough coupling disc) is preferably present between the coupling elements, which ensures the desired transmission of force if both coupling elements are pressed against each other and, in each case, thereby assume their force transmission position.

Preferably, the at least one force transmission element is designed as a ball. One or both coupling elements (which are preferably formed as discs) preferably have one or more recesses in the area between the two coupling elements or their mutual contact surfaces, as the case may be. If the coupling features its force transmission position, the force transmission element(s) project or projects at least partially into the recess(es) provided for this purpose. If a first coupling element is then moved, a torque can be transmitted to the second coupling element as a result of the positive-locking connection between the force transmission element and the recess.

If, on the other hand, a force acting against the drive is exerted on the door, which force is greater than a defined force, the force transmission element(s) leave or leaves the recess(es), whereas the coupling elements are removed from each other in the direction of their common axis of rotation. The transmission of force is interrupted.

In order to return the coupling to its starting position, the drive is then activated. In this case, the drive is operated as if it were to completely open the door(s) connected to it and close them completely before or after. Here, the coupling element on the drive side is moved relative to the stationary coupling element on the door side, until the force transmission elements once again engage in the recesses in a positive-locking manner. The coupling once again features its force transmission position.

Preferably, the drive mechanism comprises at least one sensor element, which detects the position of the door(s) connected to the drive. This may comprise, for example, a limit switch or a potentiometer. The sensor element may preferably detect the exact angular position of the door. It is also conceivable that the sensor only detects the end positions (door open or closed) of the door. Moreover, the sensor element may be connected to a control device of the drive and deactivate or activate it in a certain drive direction, if the door features a certain position. For example, it would be conceivable that the door(s), after a certain time from the opening of the same, is/are once again closed.

Furthermore, a detector, which detects the transition of the coupling from the force transmission position to the release position, is to be present. For example, the detector could be designed as a proximity sensor, which detects if one of the coupling elements moves in the transition from the force transmission position to the release position in a predetermined direction.

Preferably, the coupling elements are mounted around a common axis of rotation, whereas at least one coupling element is moved away in the direction of the axis of rotation against a loading force from the opposite coupling element, if the release position is assumed.

Preferably, the detector detects if one of the coupling elements is displaced in the axial direction of its axis of rotation (or both coupling elements are displaced in opposite directions).

Preferably, in addition or alternatively, the drive is allocated with a sensor device, which monitors the force (in particular in the form of a torque) transmitted by the drive to the door(s) allocated to the drive. If this force exceeds an amount stored, for example, in the control device of the refrigerated cabinet or the drive, the drive is deactivated or stopped. As a result, a disengagement of the coupling can be prevented if the door is moved when opening or closing against an obstacle, which, for example, is not detected by the sensor described below.

Accordingly, a corresponding sensor that detects whether a person is located at a defined distance in front of the door monitored by the sensor is advantageous. Preferably, the drive cannot be activated if, when the door is open, there is an obstacle (for example, a shopping cart) in the path of movement of the door, whereas the obstacle is detected by the sensor. Moreover, the drive is preferably not activated if, when the door is closed, there is an obstacle in the path of movement of the corresponding door, whereas this can also be detected by the sensor.

The doors could also feature an actuating element that is connected to a control device of the refrigerated cabinet, in particular of the drive; through this, a customer can signal to the refrigerated cabinet that it wants to open one or more doors.

Preferably, an actuating element is arranged on each door. Likewise, only one of a multiple number of doors, which are in operative connection with a common drive, could feature an actuating element.

In particular, the actuating element is to be able to detect an approach or a touch of a human hand. For example, the actuating element could be designed as a capacitive sensor.

If, upon the contact or approach of a hand, the actuating element emits a signal to the control device that is intended to activate the drive, this is preferably activated only if the specified sensor detects that a person is located in front of the refrigerated cabinet.

### BRIEF DESCRIPTION OF THE DRAWINGS

Further advantages of the invention are described in the following embodiments. This following is shown, in each case schematically:

FIG. 1 a front elevation view of a refrigerated cabinet,

FIG. 2 a front elevation view of the upper region of a refrigerated cabinet,

FIG. 3a a perspective view of individual elements of an upper door bearing,

FIG. 3b a perspective view of individual components of an upper door bearing,

FIG. 4a a perspective view of an upper door bearing in one possible operating disposition,

FIG. 4b a perspective view of an upper door bearing in another possible operating disposition,

FIG. 5a a perspective view of an additional embodiment of an upper door bearing in a possible operating disposition,

FIG. 5b a perspective view of an additional embodiment of an upper door bearing in another possible operating disposition,

FIG. 6 a perspective view of parts of the upper region of a door of a refrigerated cabinet,

FIG. 7 a top plan view of a components of a refrigerated cabinet,

FIG. 8a a front elevation of a coupling of a door drive in a possible operating disposition,

FIG. 8b a front elevation of a coupling of a door drive in a possible operating disposition,

FIG. 9 a cross section of a portion of a coupling of a door drive.

In the following, characteristics of refrigerated cabinets 1 and their components are described, whereas the individual characteristics can be combined as desired, provided that no obvious inconsistencies arise.

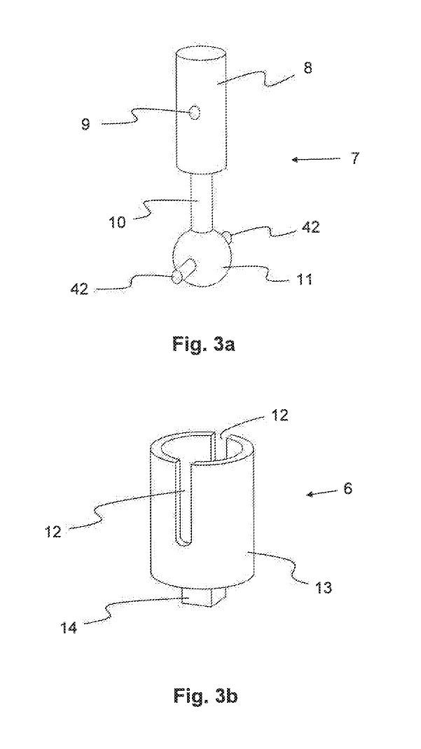

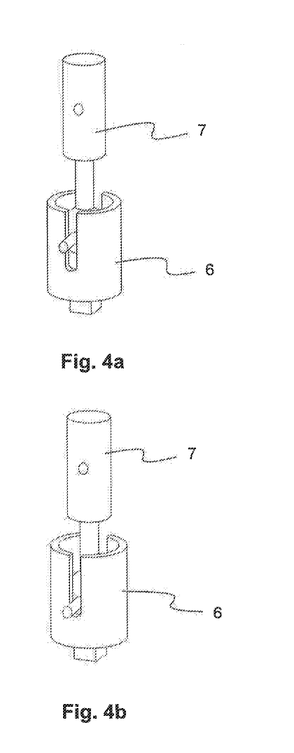

In addition, it must be noted that in figures that feature identical and thus identically represented elements or sections, in some cases, only one of the elements or sections is provided with a reference sign, in order to ensure a proper overview. Finally, it must be clarified that, in all of the figures, not all sections/components are provided with a reference sign if they have already been provided with a reference sign in earlier figures (compare, for example, FIGS. 3a, 3b, 4a, 4b).

### DETAILED DESCRIPTION

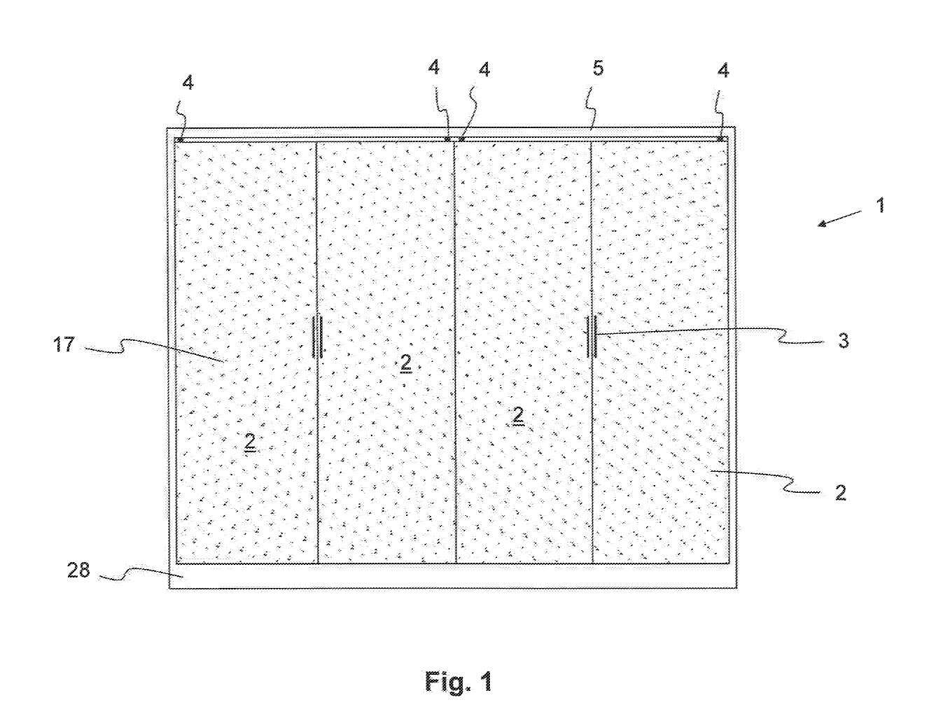

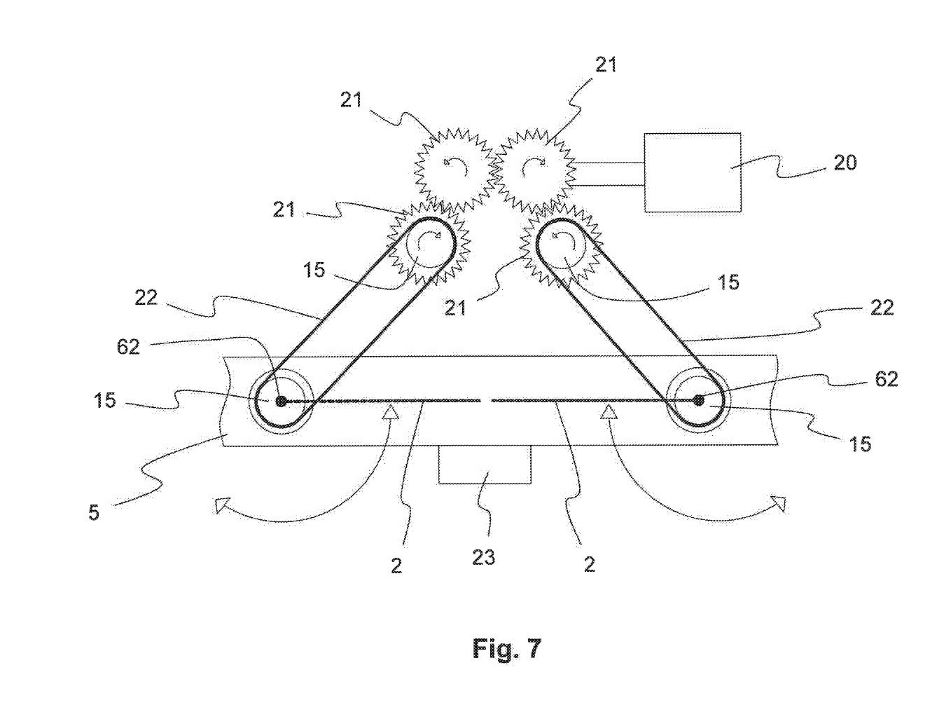

FIG. 1 shows a front view of a refrigerated cabinet 1 with a frame 28 (that is, a base element to which the other elements of the refrigerated cabinet 1 are attached, directly or indirectly), a multiple number of doors 2 that are pivotable around a vertical pivot axis 62 (FIG. 7), whereas, as a rule, the doors 2 comprise one or more glass panes 17 spaced apart from each other, which allow views into the interior of the refrigerated cabinet 1.

The mounting of each door 2 includes a lower door bearing (not shown) and an upper door bearing 4, such that each door 2 can be pivoted around its two bearings, for example with the assistance of a handle 3, between an open position and a closed position. Alternatively, it is of course also conceivable to move the doors 2 with the assistance of a drive 20 (FIG. 7), as described in more detail below.

As FIG. 1 further shows, the doors 2 are mounted through their upper door bearing 4 on or in the so-called cabinet head 5. This comprises, for example, a horizontal transverse strut that forms the upper structure of the refrigerated cabinet 1 or is arranged behind a panel.

Preferably, no vertical supports are arranged between the individual doors 2, in order not to impair the view into the interior of the refrigerated cabinet 1.

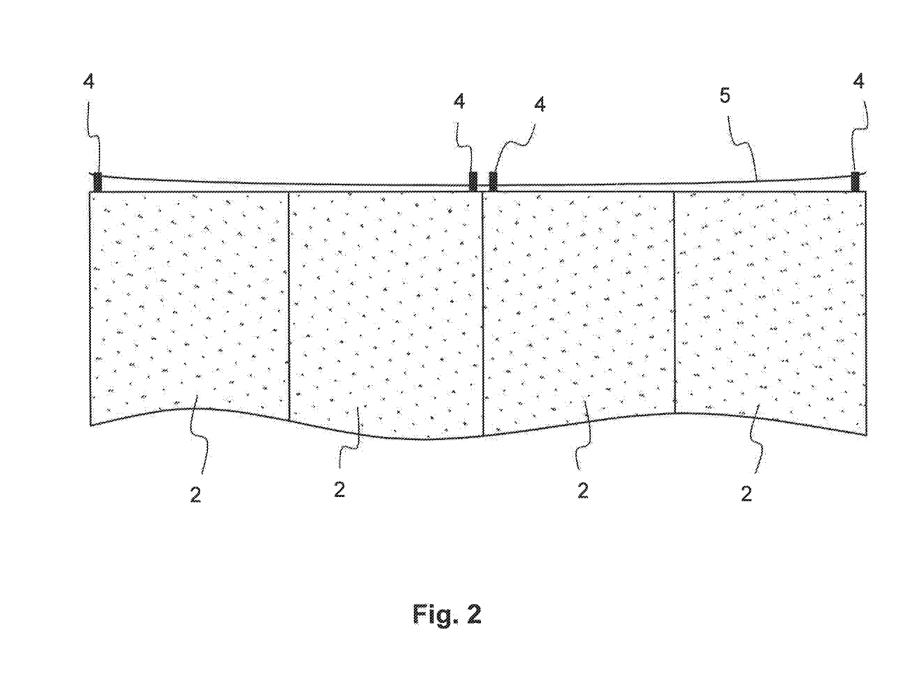

In particular, through so-called “cold forming” of the specified transverse strut or the sections of the cabinet head 5 on which the upper door bearing 4 is fixed, the cabinet head 5 that fixes or guides the upper door bearing 4 may undergo a deflection sagging toward the middle. A correspondingly formed cabinet head 5 is shown in FIG. 2.

In order to ensure that, in the course of such sagging deflection, the tilting of the upper door bearing 4 does not arise, only certain upper door bearings 4 can then be used, as shown for example in FIGS. 3a to 6.

In principle, the upper door bearings 4 in this case comprise a bearing member 6 on the door side, through which the upper door bearing 4 is connected to the door 2. Such bearing member 6 on the door side schematically shown in FIG. 3b preferably has a linkage 14, through which it can be connected to a receptacle of the door 2 in a positive-locking manner so that the bearing member 6 is held non-rotatably with respect to the door 2. Alternatively, the linkage 14 may also feature a thread, a through hole or a bulge or indentation. In any case, the linkage 14 is to be designed to connect the bearing member 6 on the door side rigidly (that is, in a torque-proof manner) to a linking fixture of the door 2.

Furthermore, the upper door bearing 4 comprises a bearing element 7 on the cabinet head side schematically shown in FIG. 3a, through which the upper door bearing 4 is mounted in the cabinet head 5 or a mounting of the cabinet head 5 provided for this purpose, as the case may be. In order to fix the bearing element 7 on the cabinet head side relative to the cabinet head 5 or the specified mounting thereof, the bearing section element 7 on the cabinet head side features an anchoring 9, which may be formed, for example, as a thread, through hole, bulge or indentation, or may include one of the specified sections.

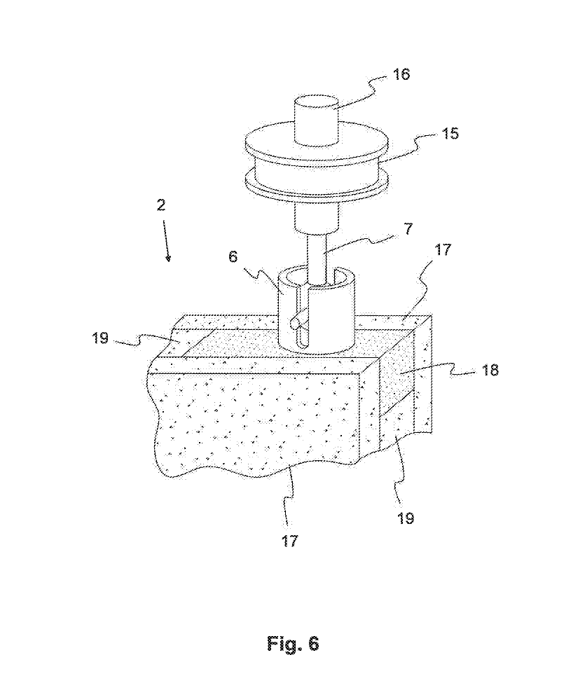

Preferably, the bearing element 7 on the cabinet head side is connected in a torque-proof manner by means of a mounting section 8 (FIG. 6) to a pulley 15 or a gear wheel 21 (FIG. 7), which in turn are mounted in the area of the cabinet head 5 (see FIG. 7).

As FIG. 3a also shows, the bearing element 7 on the cabinet head side features, in addition to and at an end of the bearing element 7 opposite the end where is disposed the mounting section 8, a ball head 11 with one or more coupling elements 42 that are formed as bolts that project laterally away from the surface of the ball head 11. In the fully assembled state of the embodiment schematically shown in FIGS. 4a to 6 of the upper door bearing 4, the bolts 42 work together with one or more corresponding slotted openings 12 defined through the sidewall of a base body 13 of the bearing member 6 on the door side. The ball head 11 is preferably connected to the attachment section 8 by means of a longitudinally extending connecting piece 10, and the bolts 42 are configured to engage the slotted openings 12 and slide freely within the slotted openings 12.

As a result, the bearing member 6 on the door side is connected in a positive-locking manner to the bearing section 7 on the cabinet head side. Nevertheless, a relative longitudinal movement between the bearing member 6 on the door side and the bearing section 7 on the cabinet head side is possible in the vertical direction (see FIGS. 4a and 4b).

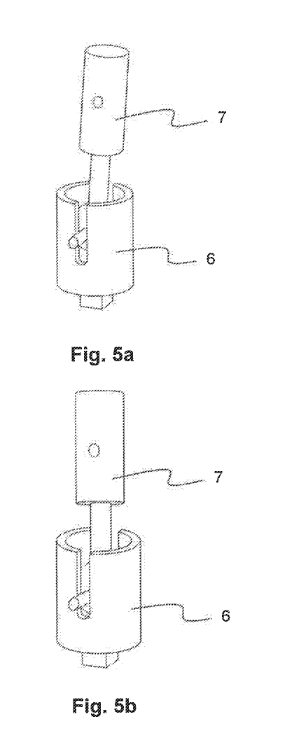

Likewise, the bearing section 7 on the cabinet head side can be tilted or pivoted relative to the bearing member 6 on the door side, as shown by the comparison of FIGS. 5a and 5b.

As a result, as schematically shown in FIGS. 6 and 7, the upper door bearing 4 that is shown enables the tilt-free transmission of force from a drive 20, which is preferably connected by means of a belt 22 or directly to a pulley 15 or a gear wheel 21, on the bearing element 7 on the cabinet head side, which finally transmits the torque generated by the drive 20 to the bearing member 6 on the door side and finally bring about a pivoting of the door 2 about the door's pivot axis 62.

In particular, this tilt-free transmission of force remains in place even if the cabinet head 5 bends in a sagging manner, and thus the spatial position of the mounting of the bearing element 7 on the cabinet head side or the specified pulley 15 or the specified gear wheel 21, as the case may be, changes just enough to compensate for the sagging of the cabinet head 5 (whereas the lower door mountings and thus the doors 2 keep their spatial position).

FIG. 6 shows that the bearing element 7 on the cabinet head side is preferably connected in a torque-proof manner to a pulley 15, which in turn is mounted in the area of the cabinet head 5, though such mounting is not explicitly shown in FIG. 6.

By contrast, as schematically shown in FIG. 6, the bearing member 6 on the door side is fixed in a torque-proof manner at or in a linking fixture defined in an insert 18 or an extension of the door 2, which insert 18 preferably extends at least partially between the glass panes 17 of the door 2. Moreover, a sealing compound 19, which is preferably transparent, is present in the edge area between the glass panes 17. Preferably, a transparent cured adhesive may be used.

If the pulley 15, as described below, is then set in motion by means of a drive 20, the pulley 15 and ultimately the door 2 rotates, such that it can be pivoted between an open position and a closed position.

A possible drive concept is schematically shown in FIG. 7, which presents a plan view from above. Two doors 2, each of which can be pivoted around a pivot axis 62, are shown. The doors 2 are schematically shown in dashed lines, since they are arranged below the indicated cabinet head 5.

Each of the pulleys 15 of the doors 2 is then connected to a gear wheel 21 by means of a respective belt 22. The two gear wheels 21 are ultimately in contact with a drive 20 by means of additional gear wheels 21, whereas the gear unit formed by the gear wheels 21 is formed in such a manner that the gear wheel 21 driven by the drive 20 (top right in FIG. 7) brings about a pivot of the doors 2 in opposite pivot directions (represented by the two-headed arrows), such that they are simultaneously opened or closed if the drive 20 is activated.

It is advantageous if the drive 20 is activated either by means of a sensor 23, which in turn sends a signal to the drive 20 if a customer is located in front of the refrigerated cabinet 1.

Likewise, it is advantageous if the activation of the drive 20, and thus the opening of the door 2, takes place by means of an actuating element. The sensor 23 may also be present in this case and may ensure that the drive 20 can be activated by means of the actuating element only if a person is located in the detection range of the sensor 23.

The closing of the doors 2 is also accomplished by the drive 20, whereas, in such case, after a certain time, the drive 20 can be activated by a control device after the door 2 has been opened or after the sensor 23 determines that there is no customer in front of the corresponding doors 2.

Moreover, the respective current position of the individual door 2 can be detected by means of a potentiometer 16, which is arranged, for example, in the vicinity of the specified pulleys 15 (see FIG. 6). Likewise, the potentiometer 16 can be used to gauge if the door 2 has reached its open position or closed position whereupon the drive 20 could be stopped by means of the potentiometer.

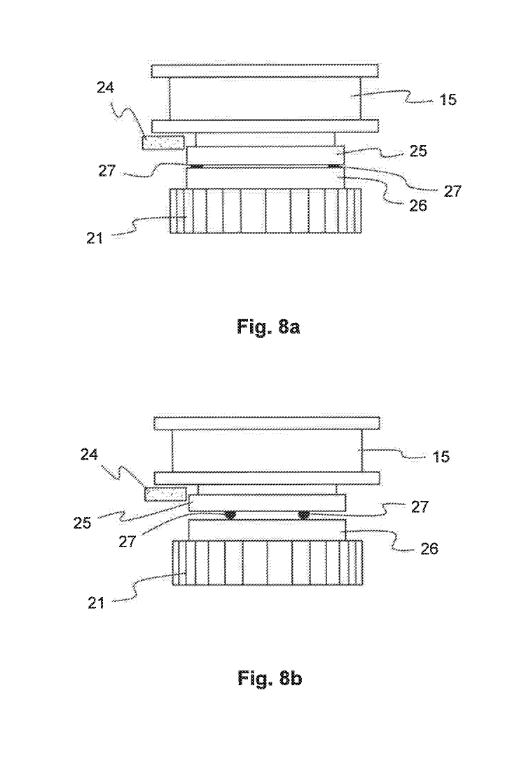

An additional advantageous characteristic is shown in FIGS. 8a and 8b. As can be seen from such figures, the pulleys 15 shown in FIG. 7 are preferably connected to the respective allocated gear wheels 21 by means of a coupling in the nature of a clutch mechanism, such that the transmission of force between the pulley 15 and the gear wheel 21, and thus between the door 2 and the drive 20, can be interrupted.

In the example shown, the coupling comprises a coupling element 26 on the drive side and a coupling element 25 on the door side (both may be formed as disks), whereas the two coupling elements 25, 26 are pressed against each other by means of a loading mechanism (for example, a spring) that is not shown.

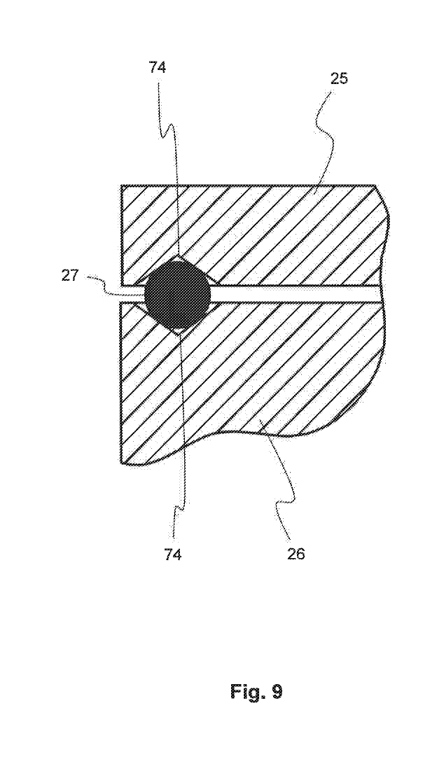

Between the two coupling elements 25, 26, there are also one or more force transmission elements 27 (preferably in the form of balls). The force transmission elements 27 project into recesses 74 of the coupling elements 25, 26 (see the section in FIG. 9). When the coupling elements 25, 26 are pressed against each other, they bring about a positive-locking connection of the two coupling elements 25, 26, if the force transmission elements 27 are located in the recesses 74 or project into them, as the case may be. If the coupling element 26 on the drive side, which is rigidly connected in a torque-proof manner to the gear wheel 21, through which the drive 20 is set in rotation, the corresponding torque is transmitted to the coupling element 25 on the door side and thus the pulley 15, and finally brings about the pivoting of the door 2.

At that point, if one of the doors 2 is moved manually and against the drive or holding force of the drive 20 in a position different from the current position, the coupling element 25 on the door side is rotated relative to the coupling element 26 on the drive side, whereas the latter is held in its position by the drive 20.

As a result of the relative movement between the coupling element 26 on the drive side and the coupling element 25 on the door side, one of the coupling elements 25, 26 is deflected, for example raised, against the loading force of the loading mechanism specified above, as schematically shown in FIG. 8b. As a result, the force transmission element(s) 27 is or are moved out of their recesses 74, such that the positive-locking connection between the two coupling elements 25, 26 is interrupted. Thus, in this case, the movement of the door 2 causes no damage to the entire drive mechanism or the drive 20 as such, as the case may be.

In order to detect the position of the coupling element 25 on the door side and thus a triggering of the described disengagement operation, a detector 24 (for example, a proximity sensor) may be present. If the detector 24 detects a movement of the coupling element 25 on the door side in the direction of its axis of rotation 62, then the control device detects that the disengaging process has been triggered.

Finally, as soon as the sensor 23 described above detects that there is not any person located in front of the refrigerated cabinet 1, then the drive 20 is set in motion. In doing so, the drive 20 is operated in such a manner that it successively assumes its two end positions, which the drive 20 assumes if the drive 20 completely opens or closes the doors 2. As a result, the coupling element 26 on the drive side sooner or later assumes a position in which the coupling element 26 attains a position relative to the coupling element 25 on the door side, in which the force transmission elements(s) 27 once again work together with the corresponding recesses 74. Finally, the coupling elements 25, 26 again attain the position shown in FIG. 8a and enable the desired transmission of force between the drive 20 and the door(s) 2.

This invention is not limited to the illustrated and described embodiments. Variations within the framework of the claims, such as any combination of the described characteristics, are also possible, even if they are presented and described in different parts of the description and/or the claims, or in different embodiments, provided that there is no inconsistency regarding the teaching of the independent claims.

### LIST OF REFERENCE SIGNS

1 Refrigerated cabinet
2 Door
3 Handle
4 Upper door bearing
5 Cabinet head
6 Bearing member on the door side
7 Bearing element on the cabinet head side
8 Attachment section
9 Anchoring
10 Connecting piece
11 Ball head
12 slotted opening
13 Base body
14 Linkage
15 Pulley
16 Potentiometer
17 Glass pane
18 Insert
19 Sealing compound
20 Drive
21 Gear wheel
22 Belt
23 Sensor
24 Detector
25 Coupling element of the door side
26 Coupling element of the drive side
27 Force transmission element
28 Frame
42 key element
62 Pivot axis of the door
74 Recess

1-15. (canceled)

16. Door bearing for a door of a refrigerated cabinet having a cabinet head, the door bearing comprising:
a bearing member configured for non-rotatably fixing the door bearing member with respect to the door;
a bearing element configured for fixing the door on the cabinet head of the refrigerated cabinet;
wherein the bearing element is configured for movement in a longitudinal direction relative to the bearing member; and
wherein the bearing element is configured for pivotable movement relative to the bearing member.

17. Door bearing in accordance with claim 16, wherein the bearing member includes a connecting section that defines at least one slotted opening or indentation and/or a thread, through which the bearing member is configured to be coupled in a force-fitting manner to a linking fixture of the door.

18. Door bearing in accordance with claim 16, wherein the bearing member includes a connecting section in the form of at least one slotted opening or indentation and/or a thread, through which the bearing member is configured to be coupled to a linking fixture of the door in a torque-proof manner with respect to the door.

19. Door bearing in accordance with claim 16, wherein the bearing element and the bearing member are exclusively in contact with each other in a positive-locking manner.

20. Door bearing in accordance with claim 16, wherein the bearing element and the bearing member are configured so as to be manually separated from each other without tools and without releasing positive-locking between them.

21. Door bearing in accordance with claim 16, wherein the bearing member defines one or more slotted openings engaged by the bearing element.

22. Door bearing in accordance with claim 16, wherein the bearing member includes a base body formed by a sidewall that defines a cavity that receives one end of the bearing element, wherein the cavity is dimensioned so as to permit movement of the one end of the bearing element in the longitudinal direction relative to the bearing member.

23. Door bearing in accordance with claim 22, wherein the one end of the bearing element defines a ball-shaped end section with a bolt projecting laterally away from the surface of the ball-shaped end section, wherein the cavity is defined by a sidewall that includes a slotted opening that slidably engages the bolt.

24. Door bearing in accordance with claim 16, wherein the bearing member includes a base body formed by a sidewall that defines a cavity that receives one end of the bearing element, wherein the cavity is dimensioned so as to permit pivotal movement of the one end of the bearing element relative to the bearing member.

25. Door of a refrigerated cabinet, comprising:
two glass panes disposed parallel to each other and spaced apparat from each other; and an upper door bearing coupled to the glass panes, the upper door bearing being configured in accordance with claim 16.

26. Door in accordance with claim 25, wherein the door includes an insert that is at least partially fixed between the two glass panes.

27. Refrigerated cabinet with a cabinet head, comprising:
a door coupled to the cabinet head; and
an upper door bearing coupled to the door, the upper door bearing being configured in accordance with claim 16.

28. Refrigerated cabinet in accordance with claim 27, further comprising:
a drive unit configured and disposed to selectively open and close the door; and
a clutch disposed between the drive unit and the upper door bearing.

29. Refrigerated cabinet in accordance with claim 27, wherein the upper door bearing is mounted relative to the cabinet head in a manner that is rotatable but immovable in a vertical direction.

30. Refrigerated cabinet in accordance with claim 27, wherein the bearing member and the bearing element are configured and engage in such a manner that the bearing element can be tilted relative to the bearing member over a tilt angle ranging between 1° and 20°.

31. Refrigerated cabinet in accordance with one of the claim 27, wherein the bearing element features a connecting section in the form of at least one bulge or indentation and/or a thread, through which the bearing element is connected in a force-fitting and/or positive-locking manner to a linking area of the cabinet head.
